(19) United States
(12) Patent Application Publication
(10) Pub. No.: US 2021/0046623 A1
(43) Pub. Date: Feb. 18, 2021

(54) EAR STRUCTURE OF OPERATING ROD

(71) Applicant: KABO TOOL COMPANY, Taichung City (TW)

(72) Inventor: Chih-Ching HSIEH, Taichung City (TW)

(21) Appl. No.: 16/990,345

(22) Filed: Aug. 11, 2020

(30) Foreign Application Priority Data
Aug. 14, 2019 (TW) 108129013

(51) Int. Cl. B25B 23/00; B25B 23/16

(52) U.S. Cl. CPC B25B 23/0028; B25B 23/0035; B25B 23/16

(57) ABSTRACT

An ear structure of an operating rod comprising: a main rod having a shaft and two ears, the two ears are parallelly intervally disposed at a front end of the shaft; a front end of each of the two ears is an assembling end, a rear end thereof is a connecting end connected to the front end of the shaft, a width of the connecting end is greater than a width of the assembling end, and a width of each of the two ears gradually increases from the assembling end toward a direction of the connecting end; the width of the connecting ends of the two ears is increased to increase a force-bearing strength between the ears and the shaft, so that the ears of the operating rod are capable of enhancing the strength and service life.

### BACKGROUND OF THE INVENTION

### Field of Invention

The invention relates to a hand tool, and more particularly to an ear structure of an operating rod capable of enhancing a strength of use.

### Related Art

Please refer to FIG. 1, which provides a conventional hand tool 10 including: a main rod 11 and a working head 12, a front end of the main rod 11 is provided with two parallel ears 111, a width between side edges of each of the two ears 111 is the same; the working head 12 is pivotally disposed between the two ears 111, by pivotally disposing the working head 12 on the ears 111, a working direction can be changed by rotating the working head 12 relative to the main rod 11, and a workpiece is driven by the working head 12 to tighten or loosen the workpiece.

However, when a force is applied to the conventional hand tool 10, the force is transmitted from the two ears 111 to the working head 12 through the main rod 11, and the ears 111 of the main rod 11 receive the tremendous force when being driven. Because two edges 112 of each ear 111 are flat and that makes the width between the edges 112 of each ear 111 is the same from an outer end to an inner end of the ear 111, causing poor strength at connection positions between the ends of the two ears 111 and the main rod 11. Therefore, the two ears 111 are prone to torsional deformation after bearing a force, especially at the positions connected to the main rod 11, which are particularly prone to damage during the deformation process, resulting in damage and being unusable.

### SUMMARY OF THE INVENTION

A main object of the invention is to provide a hand tool capable of enhancing a strength of ears of a shaft and enhancing the strength of bearing a force.

In order to achieve the above object, the invention provides an ear structure of an operating rod including:

a main rod with a shaft and two ears; the shaft is provided with a large-diameter portion at a front end, a diameter of the large-diameter portion is greater than a diameter of the shaft, and the large-diameter portion is provided with a tapered portion connected with the shaft and with a tapered diameter tapering toward a rear end of the shaft; the two ears are parallelly intervally disposed at a front end of the large-diameter portion of the shaft; an assembling groove is formed between the two ears; a front end of each of the two ears is an assembling end, a rear end thereof is a connecting end connected to the front end of the large-diameter portion, a width of the connecting end is greater than a width of the assembling end, and a width of each of the two ears gradually increases from the assembling end toward a direction of the connecting end.

Preferably, at least one side edge of the connecting end is formed with an inclined surface.

Preferably, two side edges of the connecting end are respectively formed with an inclined surface.

In the ear structure of the operating rod provided by the invention, a large force-bearing area can be formed at where the connecting end of the ear and the shaft are connected with each other, so when the shaft is actuated by applying a force, the connecting end is capable of bearing a strong force being applied to prevent from being damaged easily, capable of enhancing a torque and a strength of the operating rod when being used, and extending the service life.

### BRIEF DESCRIPTION OF THE DRAWINGS

In order to enable the examiner to further understand the object, features and achieved efficacies of the invention, three preferred embodiments are listed below, which will be described in detail hereinafter in conjunction with the drawings, wherein:

FIG. 1 is a side view of a conventional hand tool;

FIG. 2 is a perspective view of a main rod of one preferred embodiment of the invention;

FIG. 3 is a side view of an ear of the main rod of FIG. 2;

FIG. 4 is a side view of the ear of the main rod of FIG. 3 rotated 90 degrees;

FIG. 5 is a schematic diagram of assembly of the main rod and a working head;

FIG. 6 is a schematic diagram of operation of a first preferred embodiment of the invention;

FIG. 7 is a schematic diagram of assembly of the main rod and the working head of a second preferred embodiment of the invention; and

FIG. 8 is a perspective view of assembly of the main rod and a ratchet head of a third preferred embodiment of the invention.

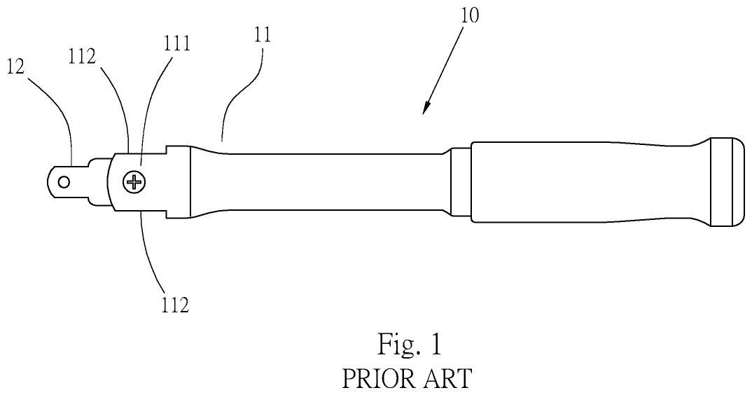

### DETAILED DESCRIPTION OF THE INVENTION

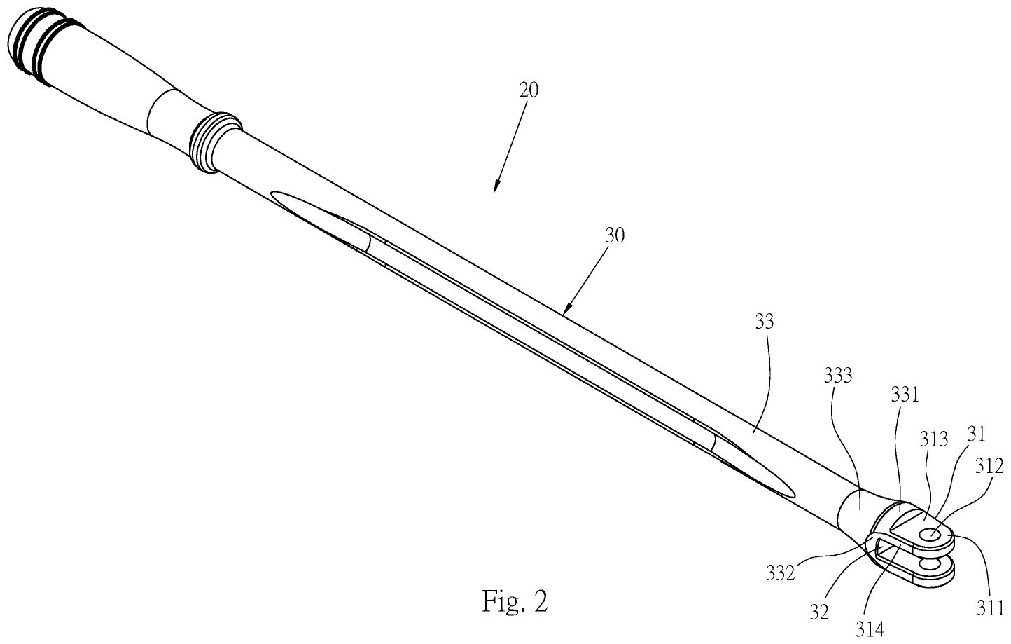

Please refer to FIGS. 2 to 5, which are a hand tool 20 provided by one preferred embodiment of the invention. The hand tool 20 includes a main rod 30 and a working head 40.

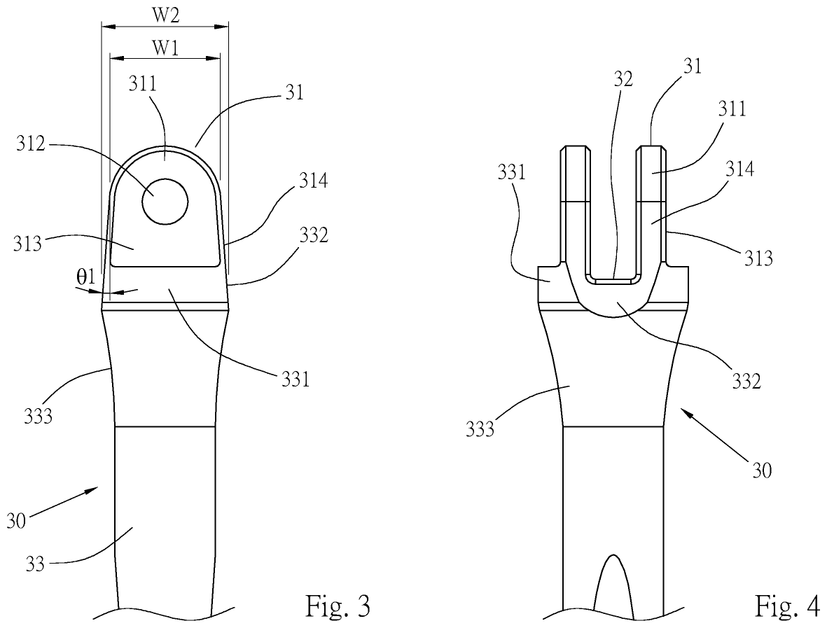

Please refer to FIGS. 2 to 3, a front end of the main rod 30 is provided with two parallel and spaced ears 31, and a rear end thereof is provided with a shaft 33. A front end of each of the two ears 31 is an assembling end 311 with a largest width of W1, a top edge of each of the two assembling ends 311 is formed as an arcuate surface, and a through hole 312 penetrates through a center of each of the two assembling ends 311. Each of the two ears 31 forms a connecting end 313 at a rear end of each of the two assembling ends 311, and a width W2 of the connecting end 313 is greater than the width W1 of the assembling end 311. A width of each of the two ears 31 gradually increases from the assembling end 311 toward the connecting end 313. In this embodiment, two side edges of the connecting end 313 are respectively formed as an inclined surface 314, or only one of the two side edges is formed as the inclined surface 314. An inclination angle θ1 of the two inclined surfaces 314 is about 4 degrees. The inclined surface 314 of the connecting end 313 can be adjusted according to requirements. If a torque to be borne is large, a larger angle θ1 can be formed, so that the connecting end 313 can produce a larger force-bearing area, and an interval of the angle θ1 is about 4 to 13 degrees. An assembling groove 32 is formed between the two ears 31, a front end of the shaft 33 is connected to the connecting ends 313 of the two ears 31, and the front end of the shaft 33 is formed with a cylindrical large-diameter portion 331, which is at a position of the main rod 30 with a largest diameter. A top surface of the large-diameter portion 331 is higher than a bottom surface of the assembling groove 32, so that the assembling groove 32 extends into the shaft 33, and a bottom side of the connecting end 313 of the ear 31 is combined with the large-diameter portion 331 to increase the force-bearing area. Positions of two sides of the large-diameter portion 331 connected to the inclined surfaces 314 of the connecting ends 313 are formed with inclined surfaces 332. The shaft 33 is formed with a tapered portion 333 at a rear end of the large-diameter portion 331, an outer diameter of the tapered portion 333 is tapered from the large-diameter portion 331 toward a rear end of the shaft 33, so that the large-diameter portion 331 and the shaft 33 can be smoothly connected.

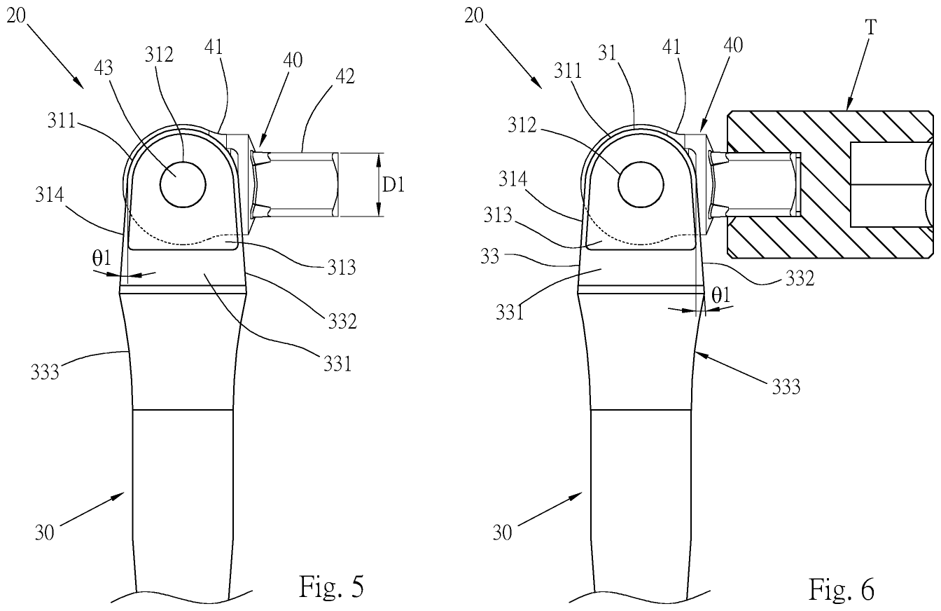

Please refer to FIG. 5 for the working head 40, which has a pivotal portion 41; and a column 42 with a top end connected to a periphery of a bottom of the pivotal portion 41. In this embodiment, the column 42 is composed of a square head, and shape and dimension thereof can be changed according to requirements. In this embodiment, a dimension D1 of the column 42 is ¼″, and the angle θ1 of the inclined surface 314 of the connecting end 313 is 4 degrees. The larger the dimension D1 of the column 42, the greater torque value the dimension D1 of the column 42 can bear, and therefore, a force borne by the two ears 31 also relatively increases, and the angle θ1 of the inclined surface 314 of the connecting end 313 also relatively increases. The pivotal portion 41 is disposed in the assembling groove 32 between the two ears 31 of the main rod 30, and a pin 43 is pivotally inserted into the through hole 312 of the two assembling ends 311 and the pivotal portion 41.

Please refer to FIG. 6, when operating the hand tool 20, a user will apply a force on the shaft 33 so that the force will be transmitted to the pivotal portion 41 of the working head 40 through the two ears 31, and then the column 42 is driven to screw a workpiece. When the two ears 31 bear the force, because the force-bearing area of the connecting ends 313 at rear ends of the two ears 31 increases, and the large-diameter portion 331 also increases the force-bearing area between the connecting ends 313 and the shaft 33; when the shaft 33 is applied with a force, a larger force can be borne between the two ears 31 and the large-diameter portion 331, a force that can be borne by the hand tool 20 as a whole can be increased, and a service life of the hand tool 20 can be enhanced relatively.

Furthermore, the inclined surfaces 314 and the inclined surfaces 332 connected with each other are capable of forming continuous connecting surfaces between the connecting ends 313 of the two ears 31 and the large-diameter portion 331 of the shaft 33, which can prevent from forming discontinuous surfaces to cause breaking at contact positions. In addition, the tapered portion 333 between the large-diameter portion 331 and the shaft 33 also forms a continuous surface between the large-diameter portion 331 and the shaft 33, which can prevent from forming a discontinuous surface to cause breaking at a contact position.

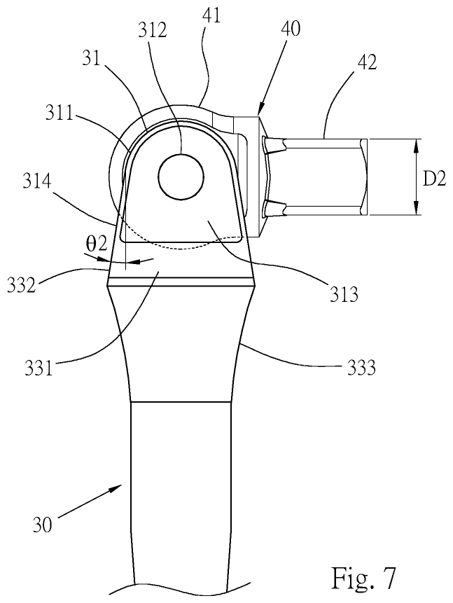

Please refer to FIG. 7, which is a second preferred embodiment provided by the invention, the main components are labeled with same numerals as those of the first preferred embodiment, and will not be repeated here, wherein:

the inclined surface 314 of the connecting end 313 of the two ears 31 has an inclination angle θ2 greater than the inclination angle θ1 of the previous embodiment, the force-bearing area at where the ears 31 and the shaft 33 connected with each other can be increased through the increased angle θ2 of the inclined surface 314 of the connecting end 313, and the working head 40 can be adapted to dispose with the column 42 with a larger dimension D2; in this embodiment, the dimension D2 of the column 42 is also relatively larger than the dimension D1 of the column 42 of the previous embodiment.

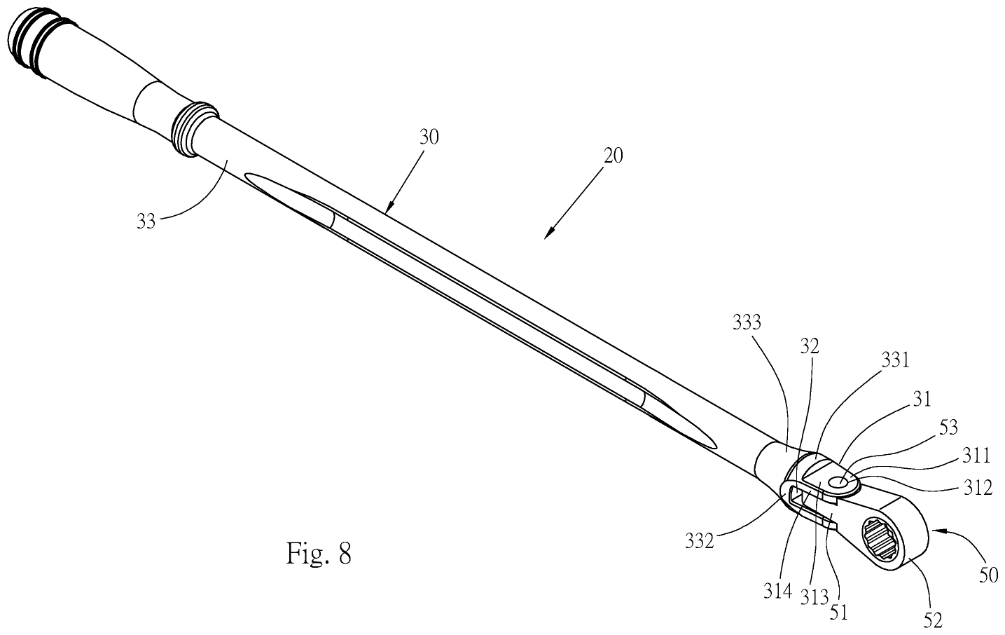

Please refer to FIG. 8 for a third preferred embodiment provided by the invention, the main components are labeled with same numerals as those of the first preferred embodiment, and the similarities will not be repeated here, wherein:

the main rod 30 of the hand tool 20 has a working head 50 connected between the ears 31; the working head 50 has a pivotal portion 51 and a ratchet head 52, the pivotal portion 51 is connected with the ratchet head 52, the pivotal portion 51 and the two ears 31 are pivotally connected by a pin 53, the ratchet head 52 of larger dimension can also be matched with the connecting ends 313 with a larger inclination angle to increase a strength of the ears 31; for the scope of application of the hand tool 20, the hand tool 20 can be combined with different types of tool heads as required in addition to the general column 42, and the ears 31 can enhance the strength of junction.

Compared with the conventional ear with a same width between the side edges of the ear, the ear structure of the operating rod provided by the invention is capable of increasing the force-bearing area at where the ears are connected with the shaft by gradually increasing the width of the connecting ends of the ears toward the shaft, thereby increasing the force-bearing strength of the ears, so that the connecting positions between the ears and the shaft can not be damaged easily to increase the operating torque and service life of the operating rod. In addition, the large-diameter portion is capable of increasing the force-bearing area between the shaft and the ears, and increasing the strength of the junction.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. An ear structure of an operating rod including:
a main rod having a shaft provided with a large-diameter portion at a front end, a diameter of the large-diameter portion being greater than a diameter of the shaft, and the large-diameter portion being provided with a tapered portion connected with the shaft and with a tapered diameter tapering toward a rear end of the shaft; and two ears parallelly intervally disposed at a front end of the large-diameter portion of the shaft; an assembling groove being formed between the two ears; a front end of each of the two ears being an assembling end, a rear end thereof being a connecting end connected to the large-diameter portion of the shaft, a width of the connecting end being greater than a width of the assembling end, and a width of each of the two ears gradually increasing from the assembling end toward the connecting end.

2. The ear structure as claimed in claim 1, wherein at least one side edge of the connecting ends of the two ears is formed with an inclined surface.

3. The ear structure as claimed in claim 2, wherein two side edges of the connecting ends of the two ears are respectively formed with an inclined surface.

4. The ear structure as claimed in claim 2, wherein an inclination angle of the inclined surface is between 4 degrees and 13 degrees.

5. The ear structure as claimed in claim 3, wherein an inclination angle of the inclined surface is between 4 degrees and 13 degrees.

6. The ear structure as claimed in claim 2, wherein the inclined surfaces of the connecting ends of the two ears extend to reach the large-diameter portion.

7. The ear structure as claimed in claim 3, wherein the inclined surfaces of the two side edges of the connecting ends of the two ears extend to reach the large-diameter portion.

8. The ear structure as claimed in claim 1, wherein a top surface of the large-diameter portion is higher than a bottom surface of the assembling groove.

9. The ear structure as claimed in claim 1, wherein the large-diameter portion is cylindrical.
